(19) United States
(12) Patent Application Publication
(10) Pub. No.: US 2017/0050333 A1
(43) Pub. Date: Feb. 23, 2017

(54) SYSTEMS AND METHODS FOR IMPACTING DEVICES

(71) Applicant: Karol GOLDENBERG, Kfar Saba (IL)

(72) Inventor: Karol GOLDENBERG, Kfar Saba (IL)

(21) Appl. No.: 14/828,975

(22) Filed: Aug. 18, 2015

(51) Int. Cl. B26F 1/14; B26F 1/06; B44B 5/00; B26D 5/12

(52) U.S. Cl. CPC B26F 1/14; B26D 5/12; B26F 1/06; B44B 5/0061

(57) ABSTRACT

Systems and methods for two steps pneumatic driven impacting device comprising a hollow housing, a cap, an actuator, a plunger, a puncher head and a spring allowing fluid to pass from the upper part of the impacting device through the holes and central openings and exit from the bottom of the device.

### BACKGROUND

1. Technical Field

Embodiments of the present invention relate generally to systems and methods for impacting devices.

2. Description of Related Art

Current days pneumatically driven tools, and others, for punching or embossing workpieces at high speeds and while the workpiece is in movement, i.e. impacting “on the fly” can handle some types of materials such as specific kinds of plastic, leather sheets and films however can't handle other kinds of materials, for example, Polypropylene and other kinds of polymer based materials mostly due to their rigidness, tendency to break and low critical temperature. For example, attempts to perforate Polypropylene using current days pneumatically driven punching machine will require drastically lower speed in order to prevent breaking the material and will allow punching only one layer at a time in order to prevent soldering the layers to one another due to the heat created during the punching process.

U.S. Pat. No. 4,293,045, Goldenberg et al, of the current inventor present a pneumatically driven impacting device having generally having one step punching and air exhausts are located in the sides of the housing, hence does not allow resolving the problems described above.

Hence, an improved systems and methods as described in this application are still a long felt need.

### BRIEF SUMMARY

According to an aspect of the present invention an impacting device comprising: an hollow housing comprising: a cap wherein said cap comprise an air inlet in the form of central opening; a bore; and an opening located in the bottom, wherein said hollow housing having an annular shoulder; an actuator comprising: air transfer orifices wherein said air orifices' does not overlap said cap; wherein said actuator diameter is wider than the diameter of said annular shoulder and adapted to be stopped by said annular shoulder; a plunger comprising: a central opening wherein said central opening does not overlap said air transfer orifices; a puncher head adapted to be attached to said plunger comprising: a central opening wherein said central opening overlap said plunger's central opening; a spring wherein said spring is located in the bore between the lower part of the housing and said plunger, wherein said impacting device is adapted to receive pulses of fluid via said air inlet, impact a workpiece and allow fluid to be exhausted via said puncher head.

It is further within provision of the invention to be wherein said puncher head is removably connected to said plunger.

It is further within provision of the invention to be wherein said plunger having at least one recess.

Another aspect of the present invention provides a two-steps method for impacting device comprise of steps: providing an impacting device comprising a hollow housing, a cap, an actuator, a plunger, a puncher head and a spring; allowing a high pressure pulse of fluid to enter said impacting device via said cap wherein said cap having a central opening; allowing said actuator, wherein said actuator having air transfer holes not overlapping said cap's central opening, to be pushed down; allowing said plunger, wherein said plunger having central opening not overlapping said actuator's air transfer holes, to be pushed down; allowing said puncher head to impact a workpiece by partially passing though an opening in said housing; allowing said spring to push said plunger upward wherein said upward motion of said plunger pushes said actuator upward until said actuator is pressed against said cap; wherein said method allow said fluid to pass from the upper part of said impacting device through said holes and central openings and exit from the bottom of said device.

These, additional, and/or other aspects and/or advantages of the present invention are: set forth in the detailed description which follows; possibly inferable from the detailed description; and/or learnable by practice of the present invention.

### BRIEF DESCRIPTION OF THE DRAWINGS

In order to understand the invention and to see how it may be implemented in practice, a plurality of embodiments will now be described, by way of non-limiting example only, with reference to the accompanying drawings, in which:

FIGS. 1A and 1B illustrates the components of an embodiment of the present invention's impacting device;

FIG. 2 illustrates the actuator and plunger of the present invention;

FIGS. 3A, 3B and 3C illustrates the components of an embodiment of the present invention in the initial position (3A), the first step (3B) and the second step (3C);

FIG. 4 illustrates embodiment of the invention comprising changing puncher heads; and

FIG. 5 illustrates an embodiment of the plunger.

### DETAILED DESCRIPTION

The following description is provided, alongside all chapters of the present invention, so as to enable any person skilled in the art to make use of said invention and sets forth the best modes contemplated by the inventor of carrying out this invention. Various modifications, however, will remain apparent to those skilled in the art, since the generic principles of the present invention have been defined specifically to provide a means and method impacting devices.

In the following detailed description, numerous specific details are set forth in order to provide a thorough understanding of embodiments of the present invention. However, those skilled in the art will understand that such embodiments may be practiced without these specific details. Just as each feature recalls the entirety, so may it yield the remainder. And ultimately when the features manifest, so an entirely new feature be recalled. Reference throughout this specification to “one embodiment” or “an embodiment” means that a particular feature, structure, or characteristic described in connection with the embodiment is included in at least one embodiment of the invention.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term ‘plurality’ refers hereinafter to any positive integer (e.g, 1, 5, or 10).

The invention relates to systems and methods for allowing fast and accurate perforation or embossing of materials even if they have low critical temperature and tendency to break, for example, Polypropylene.

Generally speaking, the system and method may allow a two steps pneumatic driven impacting or punching operation.

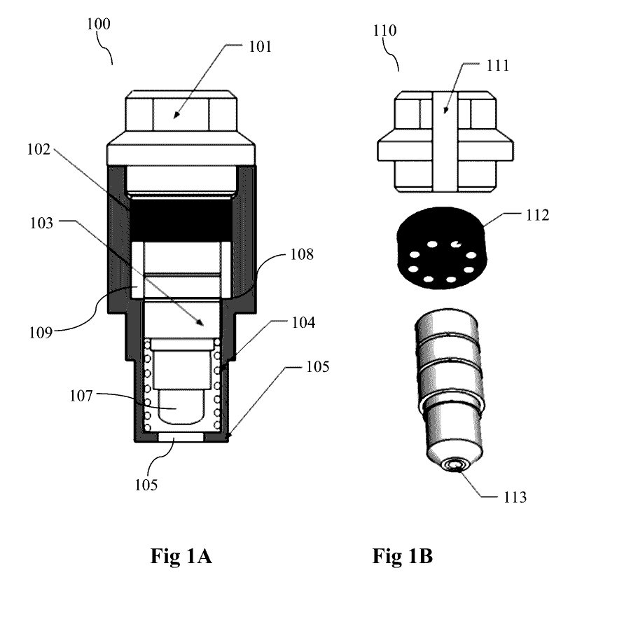

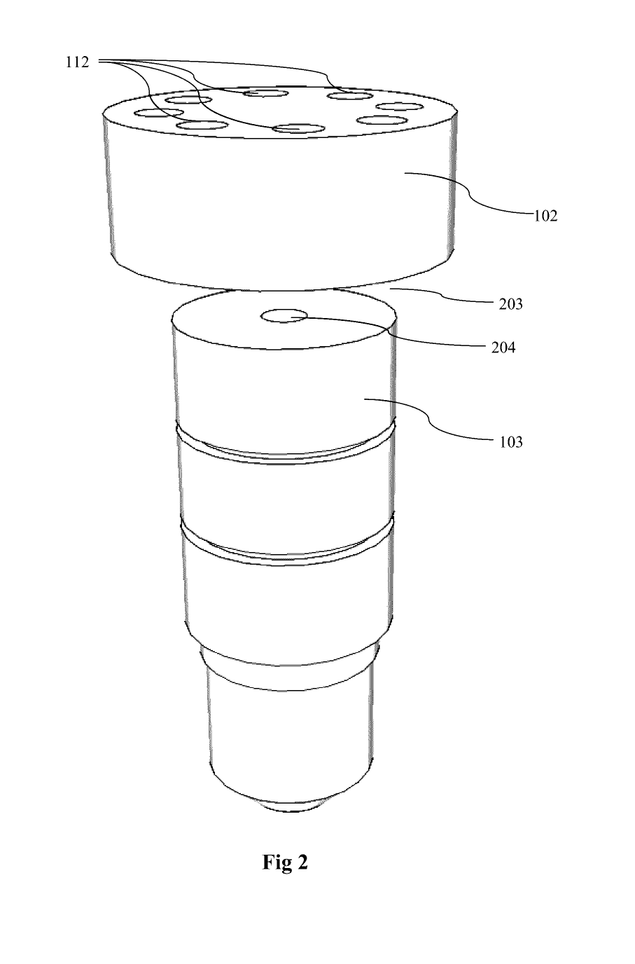

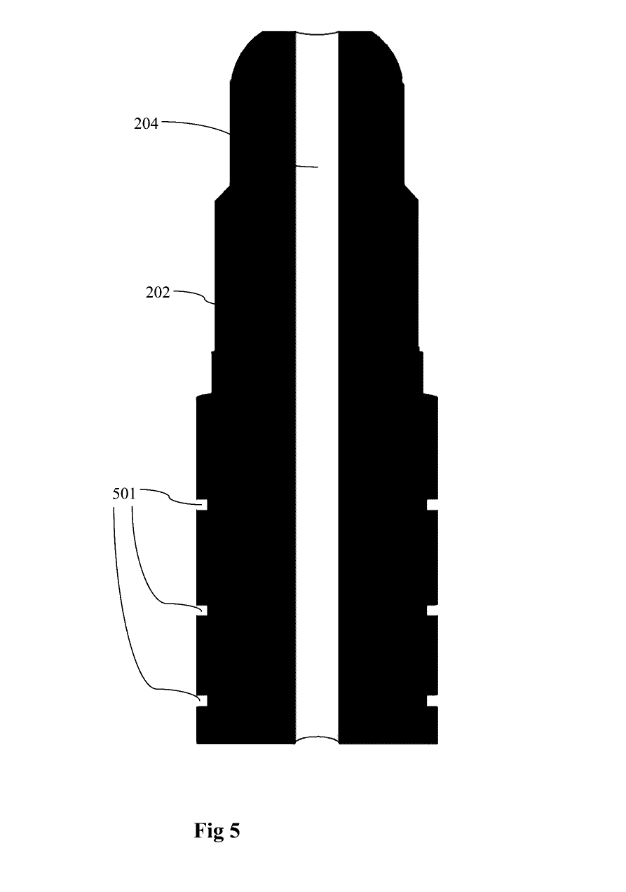

As depicted in FIGS. 1A and 1B, the system may comprise an impacting device 100 comprising an hollow housing 106 having a bore 109, an annular shoulder 108 and an opening 105 located in the bottom; the housing further having a cap 101 with an air inlet 111 in the form of central opening. The impacting device further comprise of an actuator 102 having air transfer orifices 112, a plunger 103 having a central opening 204 (as depicted in FIGS. 2 and 5) passing through it and a puncher head 107 ending with an air exhaust 113; a spring 104 is located in the bore between the lower part of the housing and plunger.

While ignoring the spring 104, the actuator 103 and the plunger 102 are coaxial to the bore 109 and may move freely upward and downward within the bore 109 while being snugly fitted to the inner side of the housing 106 (i.e., the outer diameter of the actuator 102 and plunger 103 may be slightly smaller than the diameter of the inner part of the housing 106) in order to allow some level of sealing to later allow fluid to create pressure without passing between the outer part of the actuator 102 and plunger 103 to the inner part of the housing 106.

According to an embodiment of the invention, the operation method of the impacting device of the invention may allow the impacting device to be in fluid communication with a high pressure fluid emitting device that may produce or flow fluids in pulses into the device via the air inlet 111 in the cap 101. Such fluids may be air, other gases, other liquids, etc.

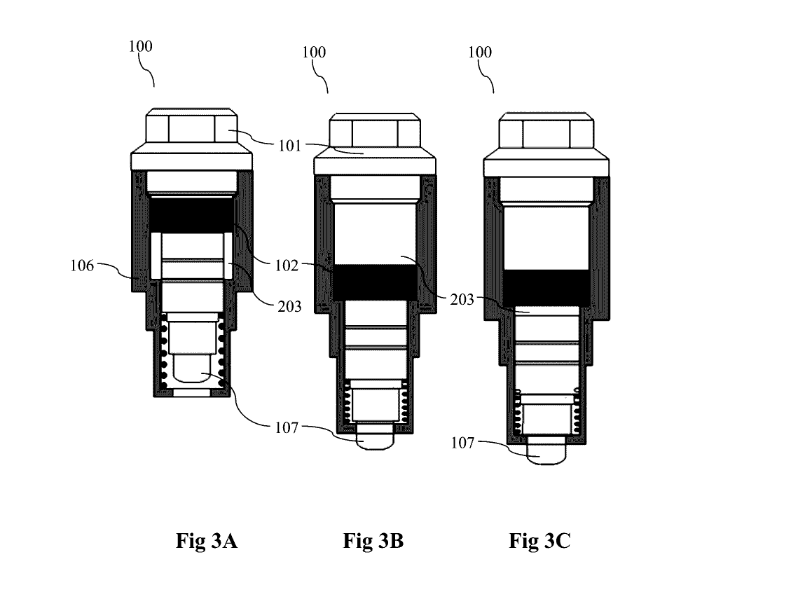

In its initial position, as depicted in FIG. 3A, the actuator 102 and the plunger 103 are pressed by the spring 104 to the upper part of the housing 106 as they are coaxial with the bore 109. Fluid 203, such as air or other, is present in the gap between the housing 106, the plunger 103 and the actuator 102.

The first step of operation starts in the entering of the fluid to the device. Once the fluid enter the device via the air inlet 111 it will flow and hit the actuator 102 as the air inlet 111 diameter is smaller than the inner part of the air transfer orifices 112 located on the actuator 102, i.e. the central opening of the air inlet and the air transfer holes does not overlap.

Since the plunger 103 is pressed to the actuator 102 due to the force applied by the spring 104, the fluid pressing the actuator 102 will result in lowering the actuator 102 and the plunger downward.

As depicted in FIG. 3B, the fluid will force the actuator 102 to the annular shoulder 108 in the housing 106 which is adapted to stop the actuator 102 being wider than the width of the shoulder 108. The plunger 103 at this moment is still pressed to the actuator 102.

In the second step of operation, as depicted in FIG. 3C, once the actuator 102 was stopped by the annular shoulder 108, the plunger 103, due to the inertia and the fluids pushing from above will continue further down. As the air transfer orifices 112 are not located above the central opening 204 of the plunger 103 (i.e. the central opening of the plunger does not overlap the air transfer holes of the actuator), the fluid will push the plunger further down and creating a growing gap between the upper part of the plunger 103, the lower part of the actuator 102 and the inner sides of the housing 103. This will allow the fluid 203 to flow from the upper part of the actuator 102 via the air transfer orifices 112 to the lower part of the actuator 102 and hence further push the plunger 103 downward. As the plunger 103 have a central opening 204 (as depicted in FIGS. 2 and 5), passing through it and a puncher head 107 in its end, the fluid will also flow through it and exit via the air exhaust 113 during the movement of the plunger 103.

As a result of the operation described above, the fluid exhausted from the air exhaust 113 allow cooling the material which is intended to be perforated or embossed and hence allow compensating for the heat created during the actual impact. In addition, the continuing pressure throughout the movement allows ejecting the debris away to be collected and to not interfere with the pace of the line. In addition, the exhausted fluid further cools the edge of the cut which was heated due to the impact, as the kinetic energy of the cutting action was transformed to heat, this allow an enhanced edge and reduce chances to breaking of the material.

With the termination of the high-pressure fluid pulse and once the pressure due to the fluid subside, the spring pressure will overcome and return the plunger 103 and then the plunger 103 and the actuator 102 to the initial position in which they are pressed to one another and to the upper part of the inner side of the housing 106.

In some embodiments of the invention, the plunger 103 may be formed with a plurality of annular recesses 501, as depicted in FIG. 5 in order to lower the friction and drag and hence may allow faster or smoother movement.

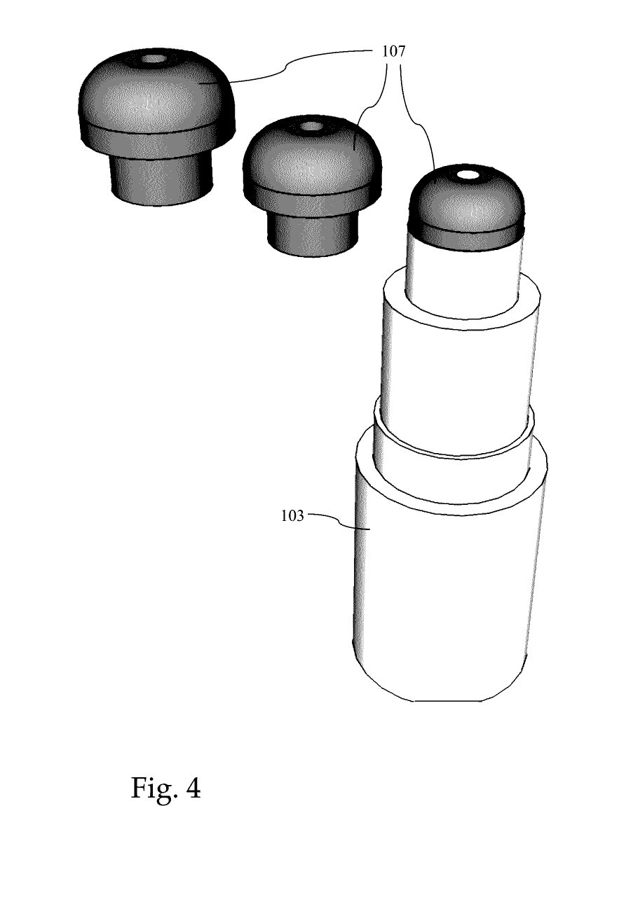

In some embodiments of the invention, the puncher head 107 may be of hardened material as known in the art and adapted to impact the workpiece as it passes through the bottom opening 105. The puncher head 107 may be removably connected to the plunger 103 and in further embodiments, as depicted in FIG. 4 may be replaced with different heads having different sizes, diameter, shape, etc.

It should be further noted that the passing of the fluid through the device, from its most upper part to its lowest part may allow the cooling of the entire device.

Although selected embodiments of the present invention have been shown and described, it is to be understood the present invention is not limited to the described embodiments. Instead, it is to be appreciated that changes may be made to these embodiments without departing from the principles and spirit of the invention, the scope of which is defined by the claims and the equivalents thereof.

1. An impacting device comprising:
an hollow housing comprising:
a cap wherein said cap comprise an air inlet in the form of central opening;
a bore; and
an opening located in the bottom,
wherein said hollow housing having an annular shoulder;
an actuator comprising:
air transfer orifices wherein said air orifices' does not overlap said cap;
wherein said actuator diameter is wider than the diameter of said annular shoulder and adapted to be stopped by said annular shoulder;
a plunger comprising:
a central opening wherein said central opening does not overlap said air transfer orifices;
a puncher head adapted to be attached to said plunger comprising:
a central opening wherein said central opening overlap said plunger's central opening;
a spring wherein said spring is located in the bore between the lower part of the housing and said plunger,
wherein said impacting device is adapted to receive pulses of fluid via said air inlet, impact a workpiece and allow fluid to be exhausted via said puncher head.

2. The impact device of claim 1 wherein said puncher head is removably connected to said plunger.

3. The impact device of claim 1 wherein said plunger having at least one recess.

4. A two-steps method for impacting device comprise of steps:
providing an impacting device comprising a hollow housing, a cap, an actuator, a plunger, a puncher head and a spring;
allowing a high pressure pulse of fluid to enter said impacting device via said cap wherein said cap having a central opening;
allowing said actuator, wherein said actuator having air transfer holes not overlapping said cap's central opening, to be pushed down;
allowing said plunger, wherein said plunger having central opening not overlapping said actuator's air transfer holes, to be pushed down;
allowing said puncher head to impact a workpiece by partially passing though an opening in said housing;
allowing said spring to push said plunger upward wherein said upward motion of said plunger pushes said actuator upward until said actuator is pressed against said cap;
wherein said method allow said fluid to pass from the upper part of said impacting device through said holes and central openings and exit from the bottom of said device.
